(19) United States
(12) Patent Application Publication
(10) Pub. No.: US 2011/0219076 A1
(43) Pub. Date: Sep. 8, 2011

(54) SYSTEM AND METHOD FOR INTEGRATING USER GENERATED CONTENT

(76) Inventors: Tomas Owen Roope, London (GB); Paul A. Prince, Auckland (NZ); Stephen Dickstein, Weston, CT (US)

(21) Appl. No.: 12/717,539

(22) Filed: Mar. 4, 2010

(51) Int. Cl. G06F 15/16

(52) U.S. Cl. 709/205; 709/231

(57) ABSTRACT

A system and method for generating an integrated content object. A plurality of user generated content objects may be associated with a respective plurality of slots in a grid. Adding a user generated content object to a grid may comprise determining whether a free slot in the grid is available. Adding a user generated content object to a grid may comprise scaling down user generated content objects already associated with the grid, providing free slots in the grid by increasing the number of slots in the grid and associating a user generated content object with a free slot.

### BACKGROUND OF THE INVENTION

Advancements in computing and networking technologies such as the Internet have enabled development and implementation of various systems, platforms and methods related to social aspects. In particular, since inception, the internet has been fundamentally about connecting people. Recent developments and platforms such as social networks enable users to interact in various ways, e.g., real time interaction and sharing of content. Social media and social networking has exploded in recent years and significant growth is expected to continue into the foreseeable future. While uploading video clips or other content to sites or platforms such as YouTube™, Facebook™ or Myspace™ is still extremely popular, other trends are emerging.

Recent studies show that an overwhelming majority of web video consumers choose content via social media recommendations. This trend clearly demonstrates a move away from mass broadcast and/or public publishing toward social circles related content and/or collaboration of content among niche social groups, e.g., family or friends.

Traditional platforms such as YouTube™ enable users to upload and download content to/from a public place. Although such platforms may further offer search capabilities, they are not suitable for combining or collaborating on audio or video content, for example, among a social group. Content collaboration among groups sharing common interests or ties, e.g., family members or niche social groups is a significant activity that is not supported by current platforms. In particular, user generated content (UGC) is typically produced by a single user and shared. There is therefore a need for a method, system and device for scalable collaborative content creation, for example, among social groups.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic block diagram of an exemplary system according to embodiments of the invention;

FIG. 2 schematically depicts adding a content object to an existing grid according to embodiments of the invention.

FIG. 3 schematically depicts adding a content object to a grid according to embodiments of the invention.

FIG. 4 is an exemplary flowchart describing a method of adding a content object to a grid according to embodiments of the invention; and

FIG. 5 showing high level block diagram of an exemplary computing device according to embodiments of the present invention;

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time.

Embodiments of the invention may enable implementing a collaborative online karaoke music platform. For example, one or more applications associated with a web site may allow users to create, share, and invite friends to participate in sing-along videos to the music of their choice. In some embodiments, possibly by leveraging automated algorithmic tools that correlate individual user generated content (UGC) such as video clip submissions or any other content objects, users can be seen and heard singing together, for example, in a grid containing slots that are populated by video clips of karaoke performances. In some embodiments, a platform may be designed to allow users to post video karaoke submissions and share such posts amongst members, friends or family, e.g., across the web. Embodiments of the invention may enable users to sing along with favorite songs and artists as well as with selected users, invite friends to participate in a common karaoke session, grade performances, compete or otherwise interact in association with, or with respect to, user generated content.

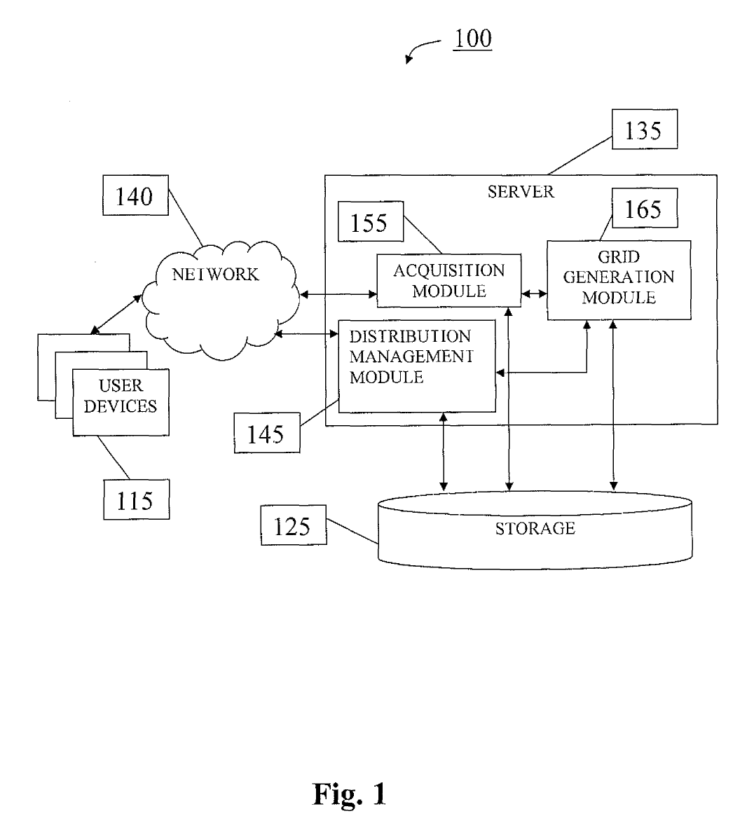

Reference is now made to FIG. 1, which shows a schematic block diagram of an exemplary system 100 according to embodiments of the invention. System 100 may include a plurality of user devices 115, a network 140, a server 135, storage 125, an acquisition module 155, a grid generation module 165 and a distribution management module 145.

According to embodiments of the present invention, user devices 115 may be client computing devices, e.g., computing devices owned and operated by various remotely located individuals. For example, computing devices 115 may be or may include a personal computer, a desktop computer, a laptop computer, a notebook computer, a terminal, a workstation, a personal digital assistant (PDA) device, a smartphone or any other suitable computing device capable of communicating over network 140, recording (e.g., using integrated or peripheral devices) or otherwise acquiring or uploading content such as multimedia content, e.g., video and audio content. Typically, computing devices 115 may also have a display and speakers for presenting video and audio content. User devices 115 may be equipped with integrated or peripheral input/output devices, e.g., display monitor, audio speakers, microphone, image capture device, e.g., video camera or webcam, keyboard, and mouse. In some embodiments, some of user devices 115 may be a mobile or cellular phone, a mobile computer or any computing device equipped with wireless communication capabilities and/or otherwise capable of wirelessly communicating with other computing devices or networks. For the sake of simplicity, the term “user device 115” may be used herein in singular form, however, it will be understood that user device 115 may refer to one or more of user devices 115. User devices 115 may have communication hardware and software, e.g., a wired or wireless modem for communication with other devices such as server 135 over a network.

Server 135 may be any server computer as known in the art, e.g., a web or application server. For example, server 135 may be or may include a personal computer, a desktop computer, a workstation, a server computer, a network device and/or any other suitable computing device.

Storage 125 may be or may include any suitable storage or database as known in the art. Accordingly, storage 125 may enable searching for content and extracting content based on keys, search patterns or any suitable criteria, e.g., as known in the art with relation to databases. Storage 125 may be or may include any commercial database or storage system.

In some embodiments, storage 125 may be or may include, for example, a hard disk drive, a Compact Disk (CD) drive, a CD-Recordable (CD-R) drive, or other suitable removable and/or fixed storage unit.

Network 140 may be, may comprise or may be part of a private or public IP network, or the internet. Network 140 may also or in addition, be, comprise or be part of a global system for mobile communications (GSM) network. For example, network 140 may include or comprise an IP network such as the internet, a GSM related network and any equipment for bridging or otherwise connecting such networks as known in the art. In addition, network 140 may be, may comprise or be part of an integrated services digital network (ISDN), a public or private data network, a local area network (LAN), a metropolitan area network (MAN), a wide area network (WAN), a wireline or wireless network, any combination of the preceding and/or any other suitable communication means. It will be recognized that embodiments of the invention are not limited by the nature, design, type or implementation of network 140, user devices 115, server 135 and storage 125. For example, these components may be commercial and/or off-the-shelf products as well as specifically designed and/or manufactured components.

Acquisition module 155, grid generation module 165 and distribution management module 145 may be or may comprise software, hardware, firmware or any combination thereof. For example, these modules may be implemented as one or more software applications to be executed on server 135. It will be understood that while an embodiment of the invention may be implemented using these modules, various other implementations may be realized. As will be evident to a person having ordinary skill in the art, functionality as described herein with respect to modules 145, 155 and 165 may be differently distributed. For example, a single application may perform functionalities described herein and attributed to these modules or, for example, the functions described herein as performed by grid generation module 165 may be performed by two or more modules.

Although embodiments of the invention described herein refer to producing a collaborative karaoke session, it will be understood that embodiments of the invention are not limited in this respect and may be applicable to any suitable collaborative multimedia content. For example, embodiments of the invention may enable a group of individuals to produce a photomontage including pictures or video content of the participating members, together with synchronous audio content, where such photomontage may be realized by a grid as described herein and may accordingly be dynamically extended to contain additional visual and audio content as it is submitted. As described herein, a grid including such visual content, e.g., video or image content may be produced by scaling the visual content and/or the existing grid of visual content contributions in order to produce such collaborative photomontage. Any visual and/or audio content, and more specifically, user generated content (UGC) may be manipulated and processed as described herein in order to generate a collaborative presentation of UGC or other content.

According to some embodiments of the invention, user devices 115 may be used to generate user multimedia content. In some embodiments, online recording of user generated content may be supported. For example, one of user devices 115 may be a home computer used by an individual to record or capture a karaoke session or performance. Such recording may be performed using standard equipment or devices known in the art, e.g., a camera and a microphone connected to a computer or a video camera with microphone that may later transfer recorded content to a computing device 115. Once captured and possibly stored on a user device 115, a captured session may be uploaded to server 135 by interacting with acquisition module 155 or as known in the art, e.g., the way video clips are typically uploaded to web servers.

In some embodiments, online recording of audio and video content may be supported. For example, a software application (not shown, hereinafter referred to as “local application”) may be downloaded and installed on user devices 115 and may control recording of video clips or karaoke sessions as described herein using local hardware. Such local application may communicate with acquisition module 155 in order to perform an online recording. The captured audio and video content may be transmitted substantially in real time to the acquisition module 155 and stored remotely from computing device 115. In other embodiments, an application executed on a web server may control the recording process. Such application may be interacted with over the internet, e.g., from within a web browser, e.g., using Flash or Java. Accordingly, online recording of a performance may be possible without requiring access to local storage.

In some embodiments, acquisition module 155 may provide a user (e.g., via a local application on the user device or over the network using a browser application) a list of songs, which may be categorized, sorted and/or searchable by artist, genre, title, album, and/or any other applicable criteria or parameter. Upon selection of a suitable track, the user may be provided with background audio content (e.g., from storage 125) suitable for performing and/or recording a karaoke performance based on the user selected track. Various search capabilities as known in the art may be implemented, e.g., by acquisition module 155 such that a user may search for a specific music style, artist, genre and the like prior to recording a karaoke performance. In some embodiments, a user wishing to record a karaoke performance may logon to server 135 and be provided with a list of songs, e.g., by a web page as known in the art. For example, a library of karaoke audio content on storage 125 may be searched or queried by acquisition module 155 based on user preferences and results may be presented to the user, enabling the user to select a suitable or desirable music track or other audio content for a karaoke session. Some embodiments may enable issuing an invitation to contribute content to a grid, in some cases, issuing an invitation may comprise issuing an authentication parameter and a parameter identifying said grid. In some embodiments of the invention, for example, as applied in the context of a social networking platform, the application may send a user an invitation to participate in a particular performance. Thus, for example, one user of the social network may select a song as described above, and designate a social group. The members of the social group may receive an invitation indicating the song to be performed and they may individually and remotely perform the selected song by recording audio and visual contributions. These contributions may then be compiled as described below.

In some embodiments, acquisition module 155 may provide a user a synchronizing signal or parameter. For example, acquisition module 155 may communicate to a user device 115 prerecorded music or sound of musical instruments in order to help and synchronize a singer recording the karaoke session. Storage 125 may store related prerecorded music or other accompaniment audio. Upon receiving a user selection, acquisition module 125 may locate (based on the selection) the relevant prerecorded music and may communicate the prerecorded music to the user device where it may be played by the local application. Storage 125 may store related lyrics. Accordingly, acquisition module 155 may obtain related lyrics or text from storage 125 and communicate such text to the user device or the local application. As known in the art, the accompaniment audio and lyrics may be provided and/or presented to the user possibly featuring timing or synchronizing indication, e.g., a marker such as a dot above a word in a line of text. Any data presented to the user as described herein and/or as known in the art may be stored on storage 125, located and extracted by acquisition module 155 (as shown by the arrow connecting blocks 155 and 125), communicated to the local application over network 140 and presented to the user by the local application on user device 115.

As described herein, possibly under control of acquisition module 155, a karaoke performance may be captured locally and communicated over network 140 to acquisition module 155. Accordingly, in some embodiments of the invention, parameters such as video resolution, audio recording quality, etc. may be determined and/or controlled by acquisition module 155 and/or the local application. For example, an originator of a collaborative multimedia project may require a minimum audio and/or video quality, such that the acquisition module may query the computing device 115 for the identity or quality of its capture hardware, and based on this, determine whether the user may submit a contribution to the project. In some embodiments of the invention, acquisition module 155 and/or the local application may control performer activities, e.g., instruct a performer to commence singing, stop singing, repeat a performance, sing louder, etc. For example, by monitoring, possibly in real time, quality or other parameter of a karaoke performance, the local application and/or acquisition module 155 may be able to guide a performer as described. In some embodiments of the invention, a project originator may direct the performances by giving certain cues to performers, which are then played at appropriate times during the song performance. For example, for the song “YMCA” by The Village People, the project originator may time certain body actions such as making the letters “Y”, “M”, “C”, and “A” by proving users a cue at these times in the song. Thus, the acquisition module may provide to performers visual cues to perform certain specific actions, e.g., by displaying text entered by the project originator at designated times in the song, so that when collated, the performances including these body actions are synchronized. In this manner, the project originator may “direct” performers for particular requirements of the collaborative performance.

Acquisition module 155 may receive a recorded karaoke performance and may store the recorded information on storage 125 and/or provide received information to grid generation module 165. Possibly but not necessarily, prior to storing information received as described herein, acquisition module 155 may process received information. For example, video content may be scaled. Other audio-visual content processing may include determining whether a recording is acceptable, for example, analysis may be performed in order to detect foul language, e.g., using word-spotting techniques or any analysis tools or methods known in the art. Any processing of content as known in the art may be performed by acquisition module 155 for example, in order to determine whether to accept or reject a performance or in order to transform a received performance to a suitable format.

In some embodiments, the actual UGC, video clip or other content may be stored in a file that may be referred to herein as a data file and any related parameters or metadata may be stored in an associated metadata file. Accordingly, a grid may be rendered by extracting content from a data file and further observing various parameters in the associated metadata file. Cross references may be created such that content in the data file is associated with parameters in the metadata file. For example, the designated slot of a specific video clip contained in the data file may be stored in the metadata file. For example, other than or in addition to the recorded karaoke performance, the local application may obtain or produce any relevant information, data or parameters and communicate such additional data or information to acquisition module 155.

For example, the local application may enable a user to provide his or her name, details such as geographic location, email address, or other information, tags, comments, etc., and may communicate such user information to acquisition module 155. Acquisition module 155 may store such additional data or metadata on storage 125, possibly associating such additional or metadata with the relevant karaoke performance that may be stored in a data file. For example, a date and time of the recording, the name of the performer, user comments, user email or other details, a name or identification of an associated group may all be stored in association with a karaoke performance. Other metadata that may be stored may relate to attributes of the recorded information, e.g., video resolution, codec parameters etc. Data provided by a user and associated with the user's generated content may be used in various ways. For example, distribution management module 145 may, upon request from a user, perform a search based on any applicable criteria, e.g., metadata files associated with grids or performances may be searched for a specific user, a specific date or the like. Results of such searches may be presented to a user and, possibly based on a user selection, relevant performances or grids may be downloaded to a user device or presented on a web page. Accordingly, a user may be able to search for, and be provided with, performances of relatives, family members, or performances related to a specific title, genre, musical style, date, artist, theme, etc.

Distribution of a grid or project may be performed by any applicable method, e.g., as known in the art. For example, a grid may be presented or provided using streaming technology e.g., online streaming as known in the art and as used by various web sites in order to present multimedia content. For example, distribution management module 145 may, possibly in conjunction with a required web application or server, enable users to view a grid over the internet, e.g., within a web page. In other embodiments, a moving picture expert group-4 (MPEG-4) or other format file may be distributed by distribution management module 145. Distribution of grids may be based on various parameters. For example, while streaming of some grid content may be free for users to view over the internet as described, providing a MPEG-4 or other version of a grid for download may be permitted only based on payment of a fee. In yet another embodiment, a grid or project may be provided on a storage media. For example, family members may collaborate in producing a grid or project as described herein and may further be provided with a compact disk (CD) on which the project may be stored. For example, a gift CD may be thus produced for a family member's birthday. Such disk may be ordered, for example, over the internet as known in the art. Distribution management module 145 may be configured to receive such orders and provide grid content and shipment details to a system configured to produce and ship a CD as known in the art.

According to embodiments of the invention, grid generation module 165 may generate a grid comprising a plurality of slots, e.g., in the shape of a square or rectangle. While other shapes are possible, a square-shaped grid will be used for purposes of illustration herein. Each slot in such grid may accommodate one presentation. Accordingly, a number of karaoke performances may be simultaneously presented by, or within, a single grid. A grid may be stored (e.g., on storage 125) as a single file and may be downloaded from storage 125 to a user device. For example, a grid populated with a plurality of karaoke performances may be generated by grid generation module 165, stored on storage 125 and, possibly at a later stage, retrieved from storage 125 by distribution management module 145 and provided, over network 140 to any one of user devices 115. A grid may be stored as a single file or in two or more files that may contain any required information, data or parameters required in order to render, present, or otherwise provide the grid for presentation on a user device. A grid may further be associated with a metadata file that may contain any required parameters or information as described herein.

According to embodiments of the invention a grid may be created upon a user request. For example, a user operating user device 115 may be provided, by server 135, with a web page that may enable a user to provide parameters such as a grids name, an initial size (e.g., number of slots initially in the grid) and/or other parameters. Upon receiving a request to generate a new grid, grid generation module 165 may create an empty grid and an associated metadata file. The newly created metadata file may contain parameters such as the grid's name, if provided, date of creation, size (which may be represented by number of slots or dimensions), scale parameters, and references to associated performances, e.g., a parameter associating a performance with a specific slot, a reference to the original or un-scaled performance, etc.

In some embodiments, a new grid may be created when a video clip to be inserted into the new grid is provided, for example, in order to better manage processing resources and storage capacity. Accordingly, a user wishing to cause system 100 to create a new grid may be required to provide at least one video clip, e.g., a karaoke performance, to be inserted into a slot in the newly created grid. In some embodiments, a default size of 2×2 slots may be used for newly created grids, accordingly, a grid with four (4) slots may be generated by grid generation module 165 even if only a single video clip is provided at the time of creation of the new grid, in anticipation of additional performances. The metadata file associated with the grid (and the associated data file) may be updated accordingly, namely, any parameters related to the video clip inserted into the grid may be stored therein. For example, a parameter identifying the slot occupied by the video clip, the resolution (e.g., 640×480 pixels), codec information or any other relevant data or parameters related to the video clip may be stored in the metadata file. In some embodiments of the invention, the project originator may designate a maximum grid size, such that the project may be closed when the maximum number of performances to fill the maximum grid size is captured.

In some embodiments, additional video clips may be added to, inserted into or associated with an existing grid. For example, after creating a new grid, a user may inform other users of a new project, e.g., by song title, project name, link, etc. Such other users may individually and separately capture and add their karaoke performances to the new grid. For example, prior to (or subsequent to) commencing a recording as described herein, acquisition module 155 may prompt a user to provide a grid name identifying the grid into which the recording is to be inserted. In some embodiments, a web page enabling a user to cause creation of a new grid may prompt the user to provide a list of electronic mail (email) addresses, user names, or a name of a social or other group, e.g., in a social network platform. In some “closed” projects, the project originator may require that a password be provided in order to participate in the project or in order to view or be presented with the project. A contributing user and/or a user wishing to be presented with a project (e.g., a grid containing karaoke performances) may be required to provide a password that may be associated with the project or grid. The application may communicate the password to invited users only. Accordingly, users in such list may receive an email with the grid's name and a password. In such scenario, acquisition module 155 may prompt a user for a grid name and a password, and, upon verifying these parameters, e.g., verifying that the grid name provided matches an associated password (both of which may be stored in the associated metadata file), acquisition module 155 may enable a user to add his or her karaoke performance to an existing grid.

In some embodiments, a user may create and update an address book that may be similar to an electronic address book as known in the art, e.g., in electronic mail applications or social network applications or platforms. An invitation to view, participate or otherwise be associated with a collaborative or other karaoke performance as described herein may be generated using such an address book. For example, using a suitable interface provided by a web or other server, a user may send an invitation to participate in a collaborative karaoke performance to all users in her address book, to a predefined list of selected users, for example, as designated by a group name, or to a specific user selected from her address book. In some embodiments, users may send and receive open invitations to participate in projects. For example, a user may issue an open invitation that may be received by any user who opted to receive such open invitation, possibly from users with whom they have no connection otherwise. In some embodiments, a user may register to receive invitations. For example, a user may register with distribution management module 145 to receive any invitation made by any user or to only receive invitations from a predefined list of users, or based on certain criteria, e.g., genre, song, artist, etc. For example, such registration as well as any applicable preferences may be contained in a user profile that may be accessible to distribution management module 145, e.g., a user profile may be stored on storage 125.

An invitation may be generated by a user as described herein or may be automatically generated. For example, based on configuration parameters or commands from an operator, grid generation module 165 may generate a grid and may further inform distribution management module 145 of such newly created grid or project. Distribution management module 145 may issue invitations to users based on any applicable parameters. For example, invitations may be sent to users who elected to receive any invitation or invitations may be sent based on the specific content of the new grid and user preferences or profiles. For example, invitations to participate in a new project that features a specific artist or group may be sent to users who have indicated an interest in the artist, group, or a musical genre associated therewith. Any information, e.g., specifically provided by users, or otherwise collected, may be used in order to generate or inform user profiles, which may be used to select invitees for a collaborative performance as described herein.

A grid or project, e.g., one created by grid generation module 165, may be associated with an artist or performing group. Accordingly, users may automatically receive invitations (e.g., by distribution management module 145, as described herein) to perform in the same grid with the artist or group. A grid associated with an artist or group may be generated upon request of the artist/group, e.g., as a marketing tool to promote a new single, a user, or it may be generated automatically, e.g., a new grid may be generated on a weekly basis based on pop chart related data or other criteria. For example, a grid featuring a top selling video clip may be automatically and periodically generated by grid generation module 165 and invitations to participate in such grid may be automatically distributed by distribution management module 145). In some embodiments, creating and/or participating may be free of charge, while in other embodiments creating or participating in a project or grid as described herein may be associated with a fee. For example, by paying a fee, a user may be reserve a slot in a grid, particularly where a limited maximum number of slots are provided. In some embodiments, upon receiving a request and payment, grid generation module 165 may insert a provided content object into a selected slot in a grid or may reserve a specific slot in a specific grid for the paying user. The user may provide a password that may be associated with the slot, thus preventing any other users from inserting their clip into the reserved grid. Reservation of slots may be done in advance, for example, a user may reserve slots in future grids that may be created as described herein. For example, a list of grids to be generated over the next month may be published in advance enabling user to reserve slots in such grids even before they are created.

A price for a slot may be based on the slot's location, e.g., the slots closer to a center of a grid may cost more than ones close to the edge of the grid. A price may be based on the grids attributes, e.g., participating in a small grid of 50 slots may cost more than participating in a 1000 slots grid or participating in a project or grid featuring a well-known or successful performer may cost more than participation in a projects featuring less famous performers, etc.

According to embodiments of the invention, a karaoke performance recording acquired by acquisition module 155 may be stored in storage 125 as shown by the arrow connecting blocks 155 and 125 and/or provided directly to grid generation module 165 as shown by the arrow connecting blocks 155 and 165. Accordingly, grid generation module 165 may obtain a clip for insertion into a grid from either acquisition module 155 or storage 125. The process of inserting a new clip into a grid may comprise determining whether a free slot in the grid is available. The process of inserting a new clip or content object into a grid may comprise adding slots to the grid and inserting the new content object into a slot made available by such addition of slots.

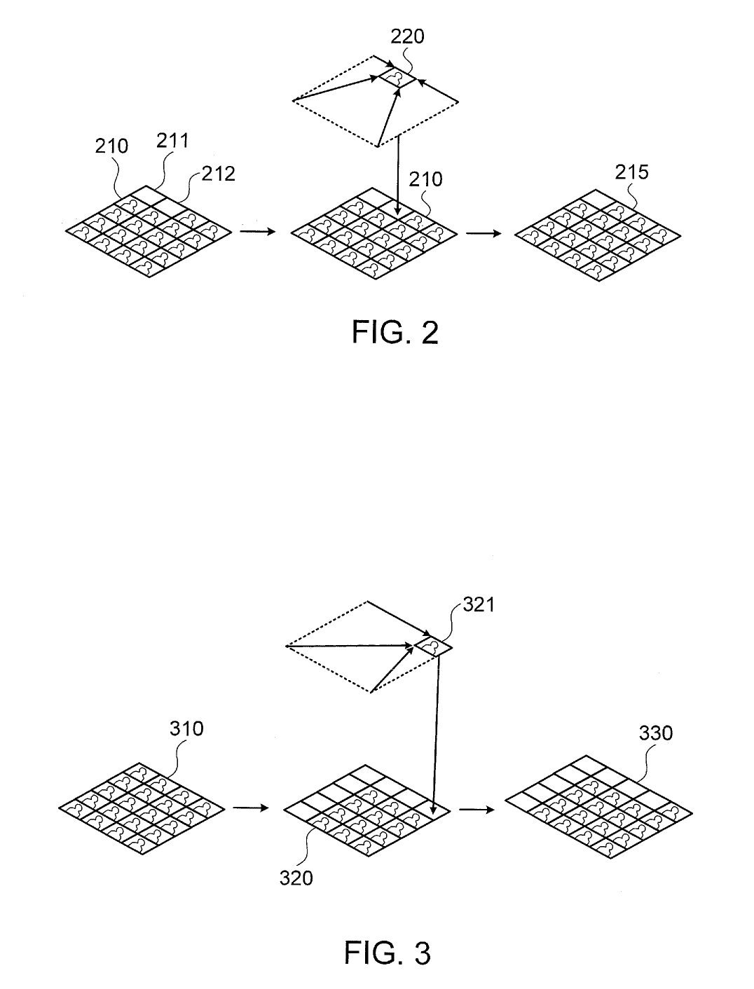

Reference is now made to FIG. 2 which schematically depicts adding a content object to an existing grid. As shown by 211 and 112, two slots in grid 210 may be free or unoccupied. For example, information related to free slots in a grid may be stored in the metadata file associated with the grid as described herein. Accordingly, upon receiving a new clip to be added to a grid, grid generation module 165 may examine the relevant metadata file and determine that free slots are available in the grid. Grid generation module 165 may further determine which slots are available based on information in the metadata file, for example, a list in the metadata file representing slots in a grid may indicate the status of each slot, e.g., an entry in the list may indicate that the slot is free or identify the clip occupying the slot. Information in the metadata file may further enable grid generation module 165 to determine the current scaling, scale factor or scaling parameter value related to the grid and the associated clips. Accordingly as depicted by 220, the clip to be inserted into the grid may be scaled accordingly so that its scaling matches the scaling of clips already populating the grid and may further be associated with a free slot. As shown by 215, the new clip may be added to the grid by inserting it into slot 212.

According to embodiments of the invention, if no free slot is available in the grid then grid generation module 165 may scale down (or downscale or downsize) clips already occupying or populating the grid, e.g., by downscaling or scaling down the entire grid containing performances, add slots to the grid, scale the new clip to match the new scale, frame size and/or resolution, of clips already populating the grid and insert the new clip into one of the free slots that resulted from increasing the number of the grid slots.

Reference is now made to FIG. 3, which schematically depicts adding a content object to an existing grid. As shown by 310, a grid of 4×4 (16) slots may have no free slots. As shown by 320, grid 310 may be modified to become a 5×5 (25) slot grid. In this example, a grid having 16 slots is modified to have 25 slots. Accordingly, the video clips in such grid may be scaled down by a factor of 4/5 in each dimension. Various considerations may effect a scale down factor that may be applied to video clips in a grid when the grid is modified. In some embodiments, predefined scale down, resolution or frame size factors related to video clips may be associated with respective predefined number of slots in a grid. Accordingly, upon detecting that a free slots in a grid are about to be exhausted, grid generation module 165 may commence a scale down (or downscale or downsize) process of related video clips. Such method may enable embodiments of the invention to accommodate submissions of performances to an existing grid quickly, even in cases where the grid needs to be modified as described, thus users may be provided with a grid including their submissions within an extremely short period of time following submission of content. It will be understood that for a grid having dimensions n×n (where n is the number of content items in a row or column), a down-scaling operation may rescale the grid to size (n+1)×(n+1), such that each clip takes up 1/(n+1) of a row or column, rather than 1/n. This may be accomplished in any of a number of ways. For example, the existing (full) n×n grid may be resized by n/(n+1), and an additional row and column of slots may be added to fill the new (n+1)×(n+1) grid. These new empty slots may be filled by new performances. The process may be repeated indefinitely. It will be recognized that advantages are obtained particularly for large values of n, by scaling the entire grid in this manner, rather than preparing a new grid based on each of the originally captured content with each re-sizing. Thus, for n=12, preparing a new grid having size n=13 and populating it with 144 originally captured performances may take a substantially long time, whereas using the above-described method, the existing grid including all performances is simply resized by a factor or 12/13, and a new row and column added to accommodate an additional 25 performances.

Any relevant information related to the grid and the associated video clips may be maintained and/or stored, e.g., in a metadata file described herein. For example, the current number of slots in the grid, the scale factor applied, the frame size allocated for presenting each of the clips, audio attributes etc. Other parameters may be clip or content specific.

Some embodiments may enable receiving a selection of a specific content object presented in a grid and presenting or providing the selected content object, e.g., presenting a selected clip in a large window or commencing a download of an un-scaled version of a clip associated with a slot that was clicked by a mouse. For example, a parameter in a metadata file may point to an un-scaled or original performance. Accordingly, by clicking on a specific slot in a grid the associated specific clip may be presented, e.g., in full screen mode or in an enlarged window. A specific clip selected from within a grid may like wise be downloaded, sent by email or otherwise handled or manipulated as known in the art. using a file containing a collaborated karaoke performance as described herein may enable users to share their own and others video karaoke submissions with a variety of online distribution platforms. For example, using a file containing a collaborated karaoke performance such collaborated performance may be provided or shared over social or other platforms such as YouTube™, Facebook™ or Myspace™.

In some embodiments of the invention, upon playback, the entire grid may be viewed and heard. Some embodiments of the invention may have certain additional features. For example, a viewer may “stand” on one performance slot in the grid and the video content of that slot may appear larger, and optionally the audio contribution of that performance may be amplified. In some embodiments, standing on a performance slot in the grid may cause the metadata associated with that performance, e.g., name and geographic location, to appear.

According to embodiments of the invention, any number of versions, different formats or other instances of video clips, karaoke performances or other content objects may be generated and stored. For example, an original karaoke performance, e.g., as uploaded by a user or recorded online as described herein may be stored on storage 125 along side a number of differently scaled downed versions. For example, acquisition module 155 may store a karaoke performance recorded online in storage 125 as received and may further scale down the received recording and store a scaled down version of the same recording, acquisition module 155 may further apply any transcoding to the received recording and store, in addition to the above mentioned versions, a version of the recording resulting from such transcoding. Grid generation module 165 may store any number of scaled down versions of a karaoke performance that may be used for populating a grid when different resolutions of a clip are needed, e.g., when the grid size is extended or reduced by adding or reducing slots to/from the grid.

According to embodiments of the invention, information, data and parameters described herein required in order to present a grid and associated clips may be stored in a downloadable file that may be downloaded to a user computer, mobile computing device or any suitable device and presented on such user device. For example, grid generation module 165 may create a file including any data required for presenting a grid and associated clips and store such file in storage 125. Such file may be downloaded to any one of user devices 115 by interacting with distribution management module 145. Distribution management module 145 may locate the relevant file based on a name of the grid provided by a user, authenticate permission of the user to receive the presentation, e.g., by receiving and verifying a password, and may further locate an associated metadata file and manage a download of such files to a user device 115. In other embodiments, the file described herein may be used to present the a collaborated karaoke performance online. For example, a file including video clips data and grid data and parameters or a number of such files, e.g., a first file including video clips and a second metadata file described herein may be used by a web server or application in order to present the grid described herein within a web page. Accordingly, users may be presented with a collaborated karaoke performance online, e.g., by a web server over the internet.

According to embodiments of the invention, various manipulations of a grid may be made possible. For example, possibly contingent on verification and/or authentication of a match between a grid name, an associated password and/or indication or identification of a specific clip, a user may cause a removal of a clip, e.g., his or her own clip from a grid. For example, upon recording and/or submitting a karaoke performance as described herein, a user may be provided, e.g., by acquisition module 155, with a unique reference number or parameter associated with the specific karaoke performance. Accordingly, using such parameter, a user may be enabled to instruct grid generation module 165 to remove the specific clip from the grid. Other manipulations may include positioning, repositioning, or relocating of a specific clip within a grid. Yet other manipulations may alter, modify or change any rendering attributes of graphical or multimedia content and/or audio content as known in the art. For example, a user may cause grid generation module 165 to place a specific clip in the center of a grid or in other positions, leave specific slots or specific location in a grid free or empty, rotate a specific clip in a specific slot, e.g., by ninety degrees (90°), enlarge a specific clip, e.g., by allocating four slots for the clip, or cause any rendering effects known in the art to be applied to a specific slot or to an entire grid. Any applicable rendering attribute of a specific slot or content object or of an entire grid may be modified, enhanced or otherwise manipulated as described herein. For example, video quality, resolution, contrast and the like. Likewise, an associated audio information may be manipulated per slot or per grid.

In some embodiments, applying such rendering or other effects to a specific clip, slot or a selected group of slots in a grid may be realized by linearly processing the data file associated with the grid in a way that may be orthogonal or unrelated to other aspects of the grid. For example, the data file described herein may be examined, a specific clip may be located therein and attributes of the clip may be modified in order to cause a specific effect. Such processing may be performed independently from other manipulations or modifications of a grid as described herein, e.g., the linear increase or decrease of a grid capacity by increasing or decreasing the number of slots therein. In other embodiments, manipulating a specific slot or multimedia in a grid may be done by modifying an associated metadata file. For example, slot allocation or association of clips with slots in a grid may be recorded in a metadata file. A rendering engine or application that performs the actual rendering of a grid on a display may use the metadata file in order to correctly render a grid. For example, a video clip in a data file may be rendered in a specific slot based on information in the metadata file. For example, changing the slot within which a clip is rendered may be achieved by modifying the metadata file to record therein an association of the clip with a different slot. Accordingly, various modifications or manipulations of a grid, and more specifically, rendering effects related to a grid, may be realized by simply manipulating parameters or information in an associated metadata file thus causing or instructing a rendering entity to affect various effects.

Various social aspects related to karaoke or other performances or any applicable UGC may be enabled by embodiments of the invention. For example, contests or competitions based on a grid described herein may involve enabling users to vote for specific clips. For example, by clicking on a specific slot in a grid a user may submit a grade, vote, thumb-up or any other selection or parameter. An application, e.g., on server 135 may collect users vote or input, compute an aggregated result and present such results, e.g., in an online contest that may be performed and viewed online, e.g., on a web page. In some embodiments, clips may be added or removed from a grid based on such contest or other users input. In other embodiments, a position of a clip within a grid, namely, the associated slot may be based on users input. For example, a position or slot of a clip within a grid may be correlated with related votes or input from users. For example, support or favorable input received for a specific clip may cause the clip to be relocated closer to the center of the grid, likewise, lack of support may cause a clip to be moved away from the center and possibly removed from a grid. In some embodiments, variable sizes may be supported, e.g., a first clip may be allocated a single slot and a second clip may be allocated two or more slots. In such cases, a different scale factor may be applied to different clips in a grid. For example, the size of clips within a grid may not be the same for all clips, for example, a clip receiving more votes or higher grades from users may be displayed in a larger slot than other, less popular clips. For example, a popular clip or a winner in a contest may be scaled up and further allocated two or four slots within a grid.

As described herein, the number of slots in a grid may be dynamic. For example, slots may be added as described herein such that a capacity of a grid in terms of slot number is increased. Likewise, a grid's capacity may be reduced. For example, upon removing one or more clips from a grid, grid generation module 165 may determine that an entire row or column may be removed from a grid. In some embodiments, reducing a grid's capacity may comprise removing at least one column and one row from the grid and may further comprise upscaling (or scaling up) content objects associated with said grid. For example, a grid of 5×5 (25) slots may have an entire row of free slots and an entire column of free slots. In such case, grid generation module 165 may modify the grid to become a 4×4 (16) slot grid. In this example, a grid having 25 slots is modified to have 16 slots. Accordingly, the video clips in such grid may be scaled up (or upscaled) by a factor of 25/16 or by a factor of 5/4 in each dimension. Such reduction of slots in a grid may allow for more rendering space for clips or other content included in a grid and may, accordingly, be desirable.

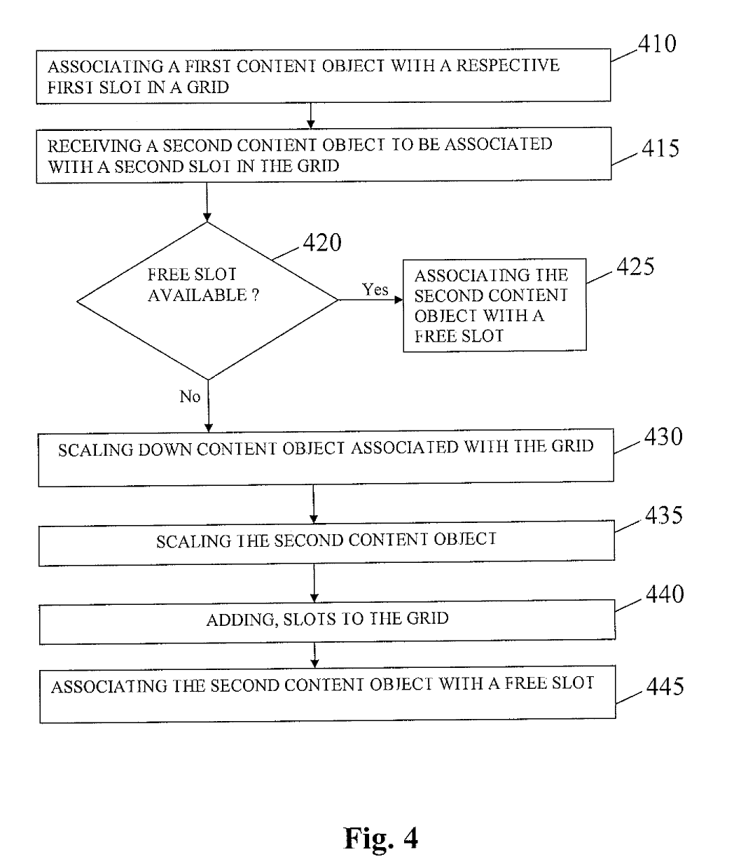

Reference is made to FIG. 4 is an exemplary flowchart describing a method of adding a content object to an existing grid according to embodiments of the invention. As shown by block 410, the flow may include associating a first content object with a respective first slot in a grid. For example, an empty grid having 4 slots, e.g., in a two by two (2×2) configuration may be created as described herein and may further be populated with karaoke performances that may be inserted into the slots of such grid.

As shown by block 415, the flow may include receiving a second content object to be associated with a second slot in the grid. For example, the 2×2 grid created as described herein may initially comprise a first karaoke performance, e.g., the one submitted by the individual who initiated the grid. Subsequent submissions may be of people invited by the initiator of the grid.

As shown by block 420, the flow may include determining whether a free slot is present or available in the grid. For example, after a fourth karaoke performance was added to a four slot grid, a fifth karaoke performance to be added to the grid may be received. For example, the creator or initiator of the grid may have invited ten family members to participate in a collaborated karaoke performance. Accordingly, when the second or third performances are received, free slots may still be available, however, after the fourth member has submitted his or her karaoke performance, the grid may comprise no free or available slots. As described herein, determining if a grid has free slots may comprise examining an associated metadata file that may store any relevant information such as the number of occupied slots in a grid.

As shown by block 425, the flow may include associating the second content object with a free slot. For example, if free slots are available, a newly received karaoke performance may be scaled to a proper scale, resolution or other parameters and may be inserted into, or associated with, an available slot. Associating a karaoke performance clip with a slot may comprise updating or creating cross references between a data file containing the actual clips and a metadata or other file containing various information, data or parameters used for rendering the grid and rendering the video clips within their associated slots.

As shown by block 430, the flow may include scaling down content objects associated with the grid. For example, if it was determined (e.g., as shown by block 420) that no free slots are available then video clips already associated with the grid may be scaled down so that they may be presented or rendered in smaller regions or slots. In some embodiments, the scale-down process may be applied to a data file (which may include a plurality of video content objects associated with the present grid) as a whole. For example, agglomerating the collaborative content, e.g., the video content of performances, in a data file may enable embodiments of the invention to apply a scale-down function to a large number of such clips by applying a single scale-down process to the data file. Accordingly, combined with the scalability of the grid in terms of slot capacity, such rapid scaling of any number of content objects may enable embodiments of the invention to quickly change dimensions of a grid and/or number of slots in a grid.

As shown by block 435, the flow may include scaling the second content object. For example, after determining a scale factor for the clips already associated with the grid, a scale down may be applied to the karaoke performance clip that is to be added so that a common or same scale may be shared by all the karaoke performance clips that will be presented in the grid.

As shown by block 440, the flow may include adding slots to the grid. For example, the 2×2 grid discussed with respect to blocks 410 and 415 may be modified to become a 3×3 grid that has nine (9) slots, thus, if the 2×2 grid was full, namely, had no free slots, such increase in grid capacity (in term of slots) would result in five new free slots. Such increase in capacity would also result in a decrease of individual slot size by a factor of 2/3 in each dimension, namely, the region available for rendering of video clips in their respective slots after such increase in capacity may be 4/9 the region previously available in each slot. Accordingly, the scaling down of video clips as described herein may be according to such factor.

As shown by block 445, the flow may include associating the second content object with a free slot. For example, after increasing the number of slots in the grid, scaling down the clips already associated with the grid and applying a proper scale to the newly received clip such that it may be rendered within a slot of the extended grid, the new clip may be associated with a slot in a manner similar to the way clips are added to a grid as described herein.

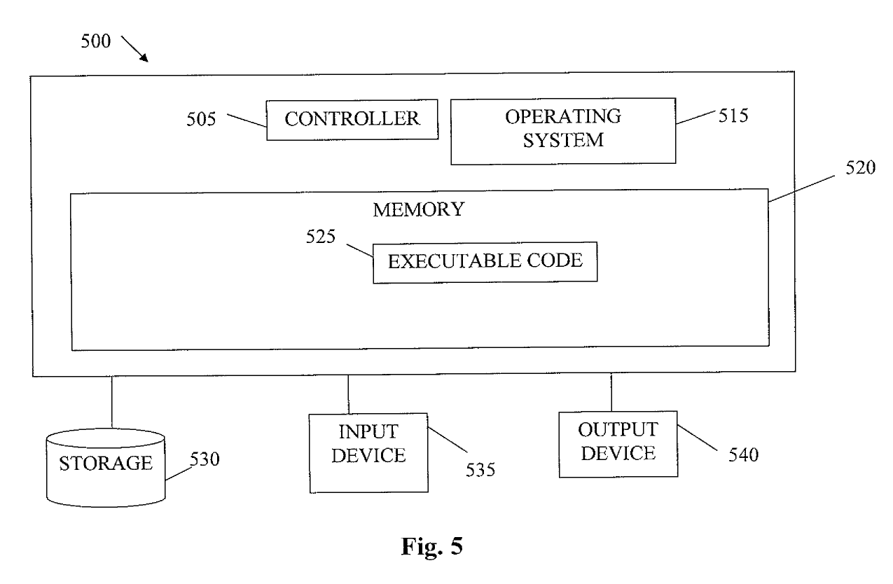

Reference is made to FIG. 5, showing high level block diagram of an exemplary computing device according to embodiments of the present invention. Computing device 500 may include a controller 505 that may be, for example, a central processing unit processor (CPU), a chip or any suitable computing or computational device, an operating system 515, a memory 520, a storage 530, an input device 535 and an output device 540.

Operating system may be or may include any code segment designed and/or configured to perform tasks involving coordination, scheduling, arbitration, supervising, controlling or otherwise managing operation of computing device 500, for example, scheduling execution of programs. Operating system 515 may be a commercial operating system. Memory 520 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 520 may be or may include a plurality of, possibly different, memory units.

Executable code 525 may be any executable code, e.g., an application, a program, a process, task or script. Executable code 525 may be executed by controller 505 possibly under control of operating system 515. Storage 530 may be or may include, for example, a hard disk drive, a floppy disk drive, a Compact Disk (CD) drive, a CD-Recordable (CD-R) drive, a universal serial bus (USB) device or other suitable removable and/or fixed storage unit.

Input device 535 may be or may include a mouse, a keyboard, a touch screen or pad or any suitable input device. It will be recognized that any suitable number of input device may be operatively connected to computing device 500 as shown by block 535. Output device 540 may include one or more displays, speakers and/or any other suitable output device. It will be recognized that any suitable number of output device may be operatively connected to computing device 500 as shown by block 540. Any applicable input/output (I/O) devices may be connected to computing device 500 as shown by blocks 535 and 540. For example, a network interface card (NIC), a printer or facsimile machine, a universal serial bus (USB) device or external hard drive may be included in input device 535 and/or output device 540. According to embodiments of the invention, server 135 and user device 115 may comprise all or some of the components comprised in computing device 500 as shown and described herein.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein. For example, a storage medium such as memory 520, computer-executable instructions such as executable code 525 and a controller such as controller 505. Some embodiments may be provided in a computer program product that may include a machine-readable medium, stored thereon instructions, which may be used to program a computer, or other programmable devices, to perform methods as disclosed above. Embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
obtaining from a plurality of users over a network a plurality of respective content objects;
associating said content objects with respective slots in a grid;
obtaining an additional content object;
if the grid contains at least one available slot, then associating said additional content object with said available slot; and
if the grid does not contain at least one available slot, then downscaling said associated content objects, adding available slots to said grid, and associating said additional content with at least one of said available slots.

2. The method of claim 1, wherein downscaling said associated content objects comprises performing substantially one downsizing operation on said plurality of content objects associated with said grid.

3. The method of claim 1, wherein said adding available slots comprises:
adding to said grid at least one of: a column of slots and a row of slots.

4. The method of claim 1, wherein said downscaling is according to a relation of a number of slots in said grid before adding available slots and a number of slots in said grid after adding said available slots.

5. The method of claim 1, comprising manipulating said grid, wherein said manipulating comprises at least one of: relocating at least one content object within said grid and modifying a rendering attribute related to at least one slot comprised in said grid.

6. The method of claim 1, wherein obtaining said plurality of content objects comprises online recording of user generated content.

7. The method of claim 1, comprising receiving an instruction to remove at least one content object from said grid and:
removing at least one of: a column of slots and a row of slots from said grid; and
upscaling content objects associated with said grid wherein said upscaling is according to a relation of a number of slots in said grid before said removing at least one of a column and a row of slots and a number of slots in said grid after said removing at least one of a column and a row of slots.

8. A system comprising:
a server comprising a processor configured to:
obtain a plurality of content objects;
associate said content objects with respective slots in a grid;
obtain an additional content object;
wherein if at least one slot in the grid is available, then said processor is configured to associate said additional content object with said available slot; and
wherein if the grid contains no available, then said processor is configured to downscale said associated content objects, and add available slots to said grid, and associate said additional content with at least one of said available slots.

9. The system of claim 8, wherein said processor is to downscale said associated content objects by performing substantially one downsizing operation on said plurality of content objects associated with said grid.

10. The system of claim 8, wherein said processor is configured to add available slots by:
adding to said grid at least one of: a column of slots and a row of slots.

11. The system of claim 8, wherein said processor is to downscale said content objects according to a relation of a number of slots in said grid before adding said available slots and a number of slots in said grid after adding said available slots.

12. The system of claim 8, wherein said processor is further to manipulate said grid by performing at least one of: relocating at least one content object within said grid and modifying a rendering attribute related to at least one slot comprised in said grid.

13. The system of claim 8, wherein said processor is to obtain said plurality of content objects by online recording of user generated content.

14. The system of claim 8, wherein said processor is to receive an instruction to remove at least one content object from said grid and based thereon, said processor is to:
remove at least one of: a column of slots and a row of slots from said grid; and
upscale content objects associated with said grid according to a relation of a number of slots in said grid before said removing at least one of a column and a row of slots and a number of slots in said grid after said removing at least one of a column and a row of slots.

15. A method comprising:
obtaining a selection of a content template, said content template comprising a background audio content and text content;
presenting over a network said content template to a plurality of participants;
receiving from said plurality of participants a respective plurality of content objects, said content objects comprising a captured video content and a captured audio content; and
generating a collaborative multimedia content item comprising the captured video content and the captured audio content.

16. The method of claim 15, wherein said plurality of received content objects are captured substantially simultaneously with a presentation of said content template to said plurality of participants respectively.

17. The method of claim 15, further comprising providing said collaborative multimedia content item to at least one viewer, wherein said collaborative multimedia content item is provided by at least one of online streaming of said collaborative multimedia content item, a storage media and downloading at least one file comprising said collaborative multimedia content item.

18. The method of claim 15, comprising:
issuing an invitation to a plurality of invitees to participate in a creation of said collaborative multimedia content item;
receiving responses from at least some invitees; and
presenting said content template to said responding invitees.

19. The method of claim 18, wherein said invitation comprises an authentication parameter and a parameter identifying a proposed collaborative multimedia content item, and wherein said invitees are required to provide said authentication parameter in order to participate in said creation of said collaborative multimedia content item.

20. The method of claim 18, further comprising selecting said invitees based on at least one common property of said invitees.

21. The method of claim 20, wherein said common property is selected from the group consisting of: an interest in a musical genre, an interest in a performing artist, and a social group.

22. A system comprising:
a server comprising a processor configured to:
obtain a selection of a content template, said content template comprising at least one of a background audio content and text content;
present over a network said content template to a plurality of participants;
receive from said plurality of participants a respective plurality of content objects, said content objects comprising a captured video content and a captured audio content;
generate a collaborative multimedia content item comprising the captured video content and the captured audio content.

23. The system of claim 22, wherein said plurality of content objects are captured substantially simultaneously with a presentation of said content template to said plurality of participants respectively.

24. The system of claim 22, wherein said processor is further to provide said collaborative multimedia content item to at least one viewer, wherein said collaborative multimedia content item is provided by at least one of online streaming of said collaborative multimedia content item, a storage media and downloading at least one file comprising said collaborative multimedia content item.

25. The system of claim 22, wherein said processor is to:
issue an invitation to a plurality of invitees to participate in a creation of said collaborative multimedia content item;
receive responses from at least some invitees; and
present said content template to said responding invitees.

26. The system of claim 25, wherein said invitation comprises an authentication parameter and a parameter identifying a proposed collaborative multimedia content item, and wherein said invitees are required to provide said authentication parameter in order to participate in said creation of said collaborative multimedia content item.

27. The system of claim 25, wherein said processor is to select said invitees based on at least one common property of said invitees.

28. The system of claim 27, wherein said common property is selected from the group consisting of: an interest in a musical genre, an interest in a performing artist, and a social group.
